(19) United States
(12) Patent Application Publication
(10) Pub. No.: US 2007/0266020 A1
(43) Pub. Date: Nov. 15, 2007

(54) Information Retrieval

(75) Inventors: Simon J. Case, Bristol (GB); Marcus S. Van Kessel, Enschede (NL)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS, London (GB)

(21) Appl. No.: 11/663,989

(22) PCT Filed: Sep. 15, 2005
(86) PCT No.: PCT/GB05/03573

§ 371 Date: Mar. 28, 2007

(30) Foreign Application Priority Data
Sep. 30, 2004 (GB) 0421754.3
Nov. 1, 2004 (GB) 0424196.4

(51) Int. Cl. G06F 17/30

(52) U.S. Cl. 707/5

(57) ABSTRACT

Apparatus for assisting a user to add a new node to an ontology stored in an ontological database especially for use in a just in time information retrieval system. The apparatus comprises analysing means for analysing one or more documents and/or groups of documents associated, by the user, with the new node to be added to the ontology, to generate a characteristic vector for the or each associated document or group of documents, preferably using a latent semantic indexing method. The apparatus further includes a classifier for performing a classification step using the or each characteristic vector to obtain one or more indications of possibly closely related nodes and thereby to identify the parent node or nodes of at least one or more of the possibly closely related nodes. Finally, the apparatus further includes display control means for controlling a display to present the identified parent node or at least one of the identified parent nodes where more than one is identified, for possible selection by the user.

### TECHNICAL FIELD

The present invention relates to a tool for assisting a user in adding new material to an information retrieval apparatus.

### BACKGROUND TO THE INVENTION

Research is currently being undertaken by several parties to produce a “just-in-time” information assistant which may be used in dynamic environments such as a call centre to help an operator to quickly retrieve relevant information from a large database, with minimal knowledge of the layout of the data by the operator. In order to perform this function effectively, efficient mechanisms for “understanding” irregularly structured user queries are required.

Such an assistant may advantageously make use of an ontological database in which an ontology is stored. The ontology stores various concepts in a structured manner and makes it easier to identify a particular concept from detected keywords, etc. which may be captured by the system from a natural conversation (either spoken or typed) between an operator and a customer. It would be desirable if such an ontology could be updated to include new concepts, especially in respect of new products to be advised on by the operator, in a semi automatic manner to minimise the burden on the person who maintains the ontology.

### SUMMARY OF THE INVENTION

According to a first aspect of the present invention, there is provided a method of assisting a user to add a new node to an ontology stored in an ontological database, the method comprising:

analysing one or more documents and/or groups of documents associated, by the user, with the new node to be added to the ontology, to generate a characteristic vector for the or each associated document or group of documents,

performing a classification step using the or each characteristic vector to obtain one or more indications of possibly closely related nodes,

identifying the parent node or nodes of at least one or more of the possibly closely related nodes, and

presenting the identified parent node or at least one of the identified parent nodes where more than one is identified, for possible selection by the user.

Preferably the step of analysing the one or more documents or groups of documents includes performing Latent Semantic Indexing (LSI) on the documents or groups of documents to generate one or more representative matrices which characterise the documents or groups of documents with a much lower dimensionality than that of corresponding term frequency matrices.

Preferably, the classification step uses a support vector machine trained on a corpus of documents pre-assigned to an original set of nodes forming the ontology as part of the initial setting up of the ontology.

Preferably the method further includes analysing the or each document to identify possibly characteristic phrases from the documents which might be good indicators of a reference to the concept associated with the new node, and presenting these as candidate phrases to the user to assist a user in identifying key phrases for associating with the new node. Preferably the analysis involves performing a residual inverse document frequency type analysis on phrases extracted from the or each document.

According to a second aspect of the present invention, there is provided apparatus for assisting a user to add a new node to an ontology stored in an ontological database, the apparatus comprising:

analysing means for analysing one or more documents and/or groups of documents associated, by the user, with the new node to be added to the ontology, to generate a characteristic vector for the or each associated document or group of documents,

a classifier for performing a classification step using the or each characteristic vector to obtain one or more indications of possibly closely related nodes and thereby identifying the parent node or nodes of at least one or more of the possibly closely related nodes, and

display control means for controlling a display to present the identified parent node or at least one of the identified parent nodes where more than one is identified, for possible selection by the user.

Preferably the ontology stored in the ontological database may be used to provide a method for accessing an information resource, comprising the steps of:

(i) receiving a user query;

(ii) comparing portions of the user query with phrases in a set of predefined phrases to find one or more matching phrases;

(iii) identifying, using predefined relationships between said predefined phrases and predefined concepts in the ontology, one or more concepts relevant to said portions of the received user query; and

(iv) identifying, using predefined relationships between predefined actions and said predefined concepts, one or more actions relevant to the received user query, wherein an action comprises providing access to an information resource.

Preferably, said predefined concepts comprise task concepts and non-task concepts, and the ontology defines, for each task concept, an indication of the number of non-task concepts required to implement a corresponding task.

In a preferred embodiment of the present invention, there is provided a further step:

(v) in the event that said one or more concepts identified at step (iii) are insufficiently specific to enable a relevant action to be identified at step (iv), identifying from the ontology one or more further concepts related to those identified at step (iii) and requesting input from a user to select one or more of said further concepts for use in step (iv) to identify a relevant action.

Apparatus according to the present invention may be applied as a “just-in-time” information assistant which uses an ontology to improve the management and selection of information to be displayed to a user. In addition to supplying information, preferred embodiments of the present invention enable user queries to be linked to business processes and people. For example, in a contact centre application the apparatus accepts an incoming message, e.g. an operator dialogue with a customer or an email, and matches the message to concepts in the ontology. Combinations of these matched concepts are then used to show information, select a business process or locate a relevant person.

The ontology is a representation of relevant entities along with important properties and their relationships. For example the products supplied by a company are the relevant entities whilst information about which are EEC compliant are important properties. In preferred embodiments of the present invention the ontology is implemented as a hierarchy in which child nodes are instances of a parent node. The ontology enables reuse of defined concepts for different domains of application and enables task-related concepts, e.g. fault, pricing information, to be identified separately from entities such as product types.

It is not just documents which can be attached to entities in the ontology, but also processes and people. A call centre operator for example may therefore be directed more quickly to the correct response in respect of a customer enquiry, i.e. relaying a piece of information, activating the correct business process or contacting the correct person.

Two interactive modes of operation of the apparatus are supported according to preferred embodiments of the present invention: in one mode the apparatus is able to carry on a dialogue with a user in order to resolve a query that is too broad; in another mode the apparatus may monitor telephonic or instant messaging conversations between a customer and a call centre operator, for example, analysing the conversation to continuously identify key concepts in the conversation and to construct relevant queries to automatically supply information, identify processes or people relevant to the subject matter being discussed with the customer.

Preferred embodiments of the present invention use an ontology:

(1) To organise resources such as documents, business processes and domain experts. It effectively provides a concept-based indexing to these resources. As the ontology is formal and highly structured, it allows fast and accurate resource retrieval using structured queries instead of merely generating a list of hits as is often returned by known answer engines.

(2) To help analyse the correct intention of a user query. The invention's dialogue module uses relationships and constraints for each of the defined concepts to ascertain relevant tasks which may apply.

Fuzzy techniques are used to map concepts in the ontology to words and phrases likely to arise in user queries and hence to handle the idiosyncrasies and unstructured nature of user queries.

According to a preferred embodiment of the present invention there is further provided an information retrieval apparatus, comprising:

an input for receiving a user query;

an ontological database for storing an ontology defining relationships between a plurality of predefined concepts;

a context phrase database for storing predefined context phrases and, for each context phrase, information defining a fuzzy relationship with an associated concept stored in the ontology;

a concept mapper for comparing portions of a received user query with context phrases stored in the context phrase database to thereby identify and output one or more relevant concepts; and

an action selector operable to identify an action in respect of one or more relevant concepts output by the concept mapper, wherein an action comprises providing access to an information resource in response to the received user query.

### BRIEF DESCRIPTION OF THE FIGURES

Preferred embodiments of the present invention will now be described in more detail, by way of example only, with reference to the accompanying drawings of which:

FIG. 1 is a diagram showing features of an apparatus according to an embodiment of the present invention;

FIG. 2 is a flow diagram showing steps in operation of a fuzzy concept mapper according to an embodiment of the present invention;

FIG. 3 is a block diagram showing the concept editor of FIG. 1 in greater detail;

FIG. 4 is a flow diagram showing steps in operation of a key phrase extraction function of the concept editor of FIG. 3; and

FIG. 5 is a flow diagram showing steps in operation of a parent node classification function of the concept editor of FIG. 3.

### DETAILED DESCRIPTION OF AN EMBODIMENT

### Overview of the Apparatus

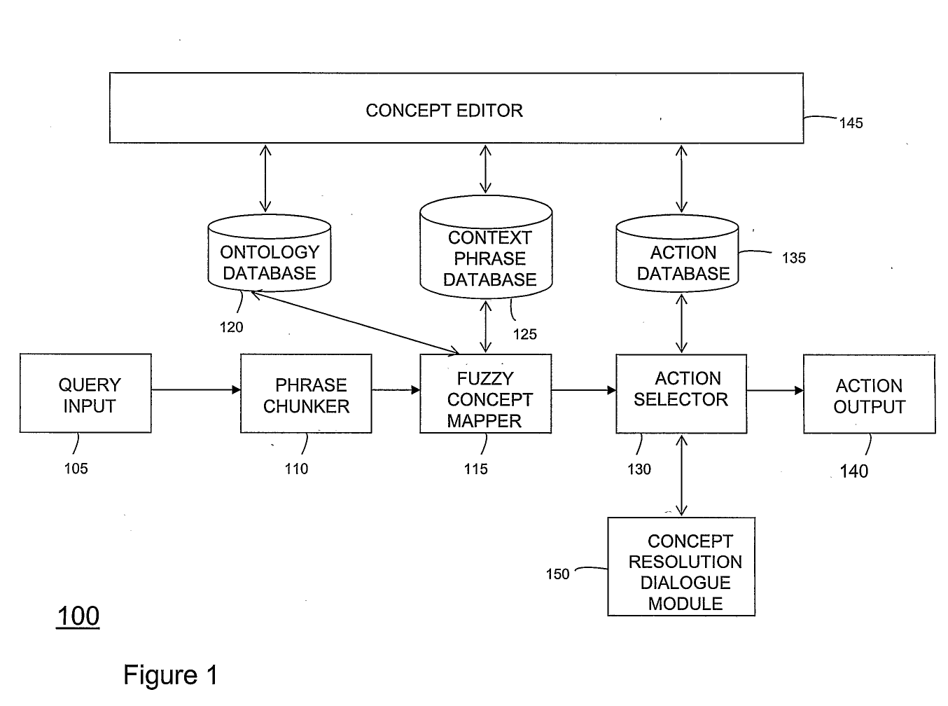

A preferred apparatus and its operation according to a preferred embodiment of the present invention will now be described in overview with reference to FIG. 1.

Referring to FIG. 1, the apparatus 100 is provided with a query input 105 arranged to receive a query from a user. Of course, a user query need not be an actual question. In a preferred call centre application of the present invention, it may be appropriate simply to ensure that relevant information is always available on-screen to the call centre operator (user of the apparatus 100) while processing a customer enquiry. On receipt of a new query at the query input 105 a new query session is initiated within the apparatus 100. The query input 105 is arranged to receive a user query by a number of different channels. For example, the query may be received in the form of an e-mail message or as a natural language query submitted by means of a web page or an instant messaging interface. Alternatively, speech recognition software may be used to convert a user's spoken dialogue into a text input to the query input 105, in real time, for processing by the apparatus 100 as the dialogue progresses.

Once a query text has been received at the query input 105, or while text is being received, it is passed to a so-called “phrase chunker” 110. The phrase chunker 110 separates input queries into smaller chunks, i.e. phrases which can be matched to concepts. Preferably, the phrase chunker 110 is arranged to divide the received query text into n-grams—sequences of n words or fewer, ideally with n<5—wherein an n-gram does not cross a sentence boundary. Alternatively, the phrase chunker may operate according to a known yet more sophisticated algorithm, designed to identify phrases of up to a predetermined length comprising words more likely to be indicative of the concepts embodied in the user query, eliminating certain “low value” words before constructing those phrases for example.

Output from the phrase chunker 110 is submitted to a fuzzy concept mapper 115 operable to identify one or more predefined concepts stored in an ontology database 120 that appear to have the greatest relevance to terms and phrases output from the phrase chunker 110. The fuzzy concept mapper 115 identifies concepts by firstly looking for context phrases stored in a context phrase database 125 that match terms and phrases contained in the query input. Predefined fuzzy relationships are maintained between concepts stored in the ontology database 120 and context phrases stored in the context phrase database 125. Therefore, having identified one or more matching context phrases (125), the fuzzy concept mapper 115 is able to identify one or more relevant concepts by analysing the respective fuzzy relationships. A more detailed description of the operation of the fuzzy concept mapper 115 will be provided below.

The fuzzy concept mapper 115 is arranged to generate and to update a list of the current concepts identified in a received user query at any one time. For example, if the user query is being captured from dialogue, the fuzzy concept mapper 115 is arranged to continually look for relevant concepts as query text is received (105) and processed by the apparatus 100, to add newly identified concepts to the current concept list and to update fuzzy support values (relevance weightings) associated with those concepts already identified. It is therefore important that when a new user query is received at the query input 105, or when it is otherwise determined that the apparatus 100 should be reset with respect to an ongoing user query, that the list of current concepts is emptied.

The fuzzy concept mapper 115 looks in the ontology (120) for relevant concepts of two types: task and non-task. The ontology (120) defines for each task concept the number and type of non-task concepts that would be required to fully define the task. The fuzzy concept mapper 115 is therefore arranged to recognise an event in which a task concept and a required number of non-task concepts has been identified in respect of a given user query and, at this point, to output the current concept list to the action selector 130. Alternatively, when the user query has been fully analysed, the current concept list is output to the action selector 130 whether or not an appropriate combination of task and non-task concepts has been identified.

The action selector 130 is designed, if necessary, to reformulate the user query in terms of the identified concepts and either to retrieve an appropriate answer to the query or relevant information, or to carry out a relevant action in respect of the user query, for example to place the user in contact with an appropriate person or service to enable an answer/information to be provided, or for the query to be otherwise progressed. The action selector 130 operates with reference to an action database 135 containing information defining a range of predetermined actions and their relationships to appropriate combinations of task and non-task concepts as defined in the ontology database 120. A more detailed description of the operation of the action selector 130 will be provided below.

Having selected an appropriate action in order to provide an appropriate answer/information or access to a relevant service for example, the apparatus 100 outputs the action to the user by means of an action output 140.

The apparatus 100 is also provided with means 150 to implement a concept resolution dialogue with a user, for example to assist the user in finding an appropriate task concept where none has been found by the apparatus 100 for a given user query, or to select a more specific non-task concept where for example the user has employed a particularly broad term in a query and a more specific term is required to fully define the task. Operation of the concept resolution dialogue module 150 will be described in more detail below.

Elements of the apparatus 100 and their operation will now be described in more detail according to a preferred embodiment of the present invention.

Referring to FIG. 1, the ontology database 120 is arranged to store a predefined ontology of concepts relevant to the domain and for each of the domains of application of the apparatus 100. For example, when the apparatus 100 is applied to supporting operators in a call centre, an appropriate ontology (120) would define entities relevant to the products and services handled by the call centre. It is this ontology that enables user queries to be interpreted and reformulated in order for the apparatus 100 to select an appropriate action in response. The ontology database 120 therefore stores an ontology comprising a formal description of the relevant entities and their relationships. Concepts are preferably arranged in a hierarchical fashion so that a given concept typically comprises a parent concept and a set of one or more child concepts. Preferably, the ontology distinguishes task concepts from non-task concepts. Task concepts are abstract tasks, e.g. fault, sales, pricing, overview, etc. Each concept may have associated with it a set of one or more properties. In particular, a non-task concept may have a property that defines, for example, whether specific task concepts can be associated with it.

By way of example, a section of an ontology as may be stored in the ontology database 120 comprises a hierarchy of concepts, as follows:

TASKS
Describe_Benefits
Pricing
Buy
Fault
Reconnect
Information
Alter_details
Compare
   prices
   features

PRODUCTS
PHYSICAL-PRODUCTS
   CORDLESS-PHONES
   ANSWERING-MACHINES
   FAXES
INTERNET-ACCESS
   DIAL-UP
   MIDBAND
   BROADBAND
PSTN
   Friends&Family

In this example, there are two types of concept in the ontology: “TASKS” and “PRODUCTS.” The ontology is arranged in a hierarchical fashion with TASKS and PRODUCTS being the root nodes of the ontology. Each “child” node under the “parent” PRODUCTS node may have properties to indicate whether particular task concepts may are associated with them. In the above example, all PRODUCTS concepts may have a has_information property set to true. The DIAL_UP concept may have the properties has_pricing_info, can_be_bought and can_have_fault all set to true, implying that it makes sense to apply the corresponding task concepts Pricing, Buy and Fault to the DIAL-UP product, whereas a Friends&Family product may have only the default has_information and alter details properties set to true because in practice that product cannot be bought and cannot be broken. Default values of certain properties associated with a parent concept may be automatically propagated to corresponding child concepts in the hierarchy if required. For example, INTERNET-ACCESS may have the properties has_pricing_info, can_be_bought and can_have_fault set to true, which also apply to each its child nodes DIAL-UP, MID-BAND and BROADBAND. This propagation can be over-ridden for individual child nodes. Thus, although PSTN may have the property can_have_fault set to true, Friends&Family may have this property set to false.

A further property—“arity”—is defined and stored for each of the task concepts in the ontology. The arity of a task defines how many non-task concepts are involved in the application of the task. In most cases the arity value of a task concept is 1. For example Pricing has an arity of 1 implying that this task is applied to only one concept at a time, e.g. how much is DIAL-UP? Or how much is an XZ70 Answering-machine? Some tasks only make sense when taking into account more than one product; the compare task for example has an arity of 2, corresponding to questions of the type: which is more expensive, DIAL-UP or MID-BAND?

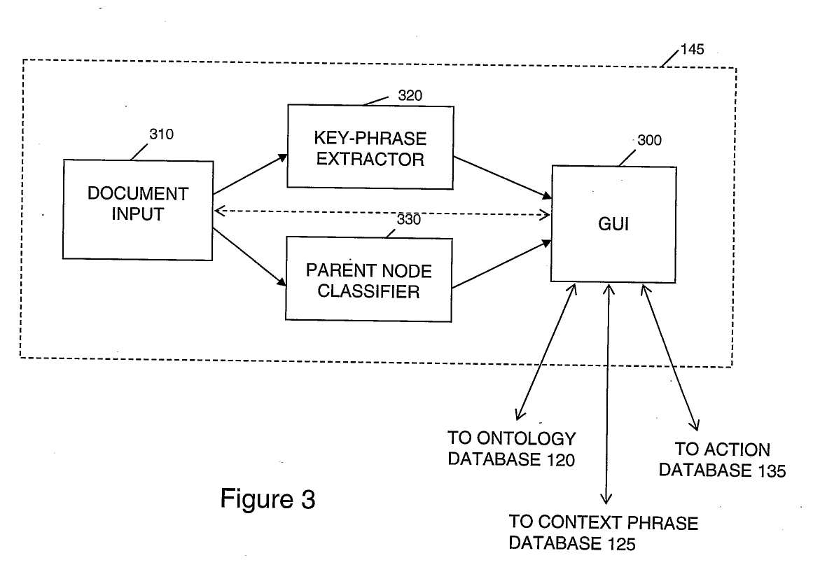

Preferably, all properties of concepts in an ontology are defined and entered into the ontology database 120 by an administrator during a configuration step when setting up the apparatus 100 for use in a particular application domain. The administrator uses a concept editor 145 to enter concepts into a hierarchy of concepts in the ontology database 120 including any task information for the concepts, to enter corresponding context phrases into the context phrase database 125 with appropriate fuzzy support values, and to define and enter actions into the action database 135. The concept editor 145 provides manual data entry facilities, but, in the present embodiment, it also provides means to derive, semi-automatically, a set of concepts relevant to an intended domain of application on the basis of a set of input documents known to contain relevant information. The processes and apparatus used in the present embodiment to extract “key terms” from an input document and to suggest where in the hierarchy of the ontology (120) a concept should be placed and which context phrases should be associated with it are described in greater detail below with reference to FIGS. 3 to 5.

For each concept defined in the ontology database 120 there is provided, in the context phrase database 125, an associated list of key phrases which are related to the concept. A fuzzy measure of support between 0 and 1 is recorded against each key phrase, indicative of the relevance of the phrase to the associated concept. For example, for the concept task:fault:, the relevant key phrases and measures of support that might be recorded in the context phrase database 125 are:

broken: 0.9

not working: 0.9

loose: 0.3

squeeky: 0.1

The context phrases selected for inclusion in the context phrase database 125 are those phrases most likely to be used in user queries. The context phrase database 125 therefore provides a link between terms that might be expected to occur in a typical user query and concepts defined in the ontology (120). This link is exploited by the fuzzy concept mapper 115 in order to identify, by comparing portions of a received user query that have been output by the phrase chunker 110 with stored context phrases (125), one or more concepts of greatest relevance to the received user query.

Fuzzy Mapping

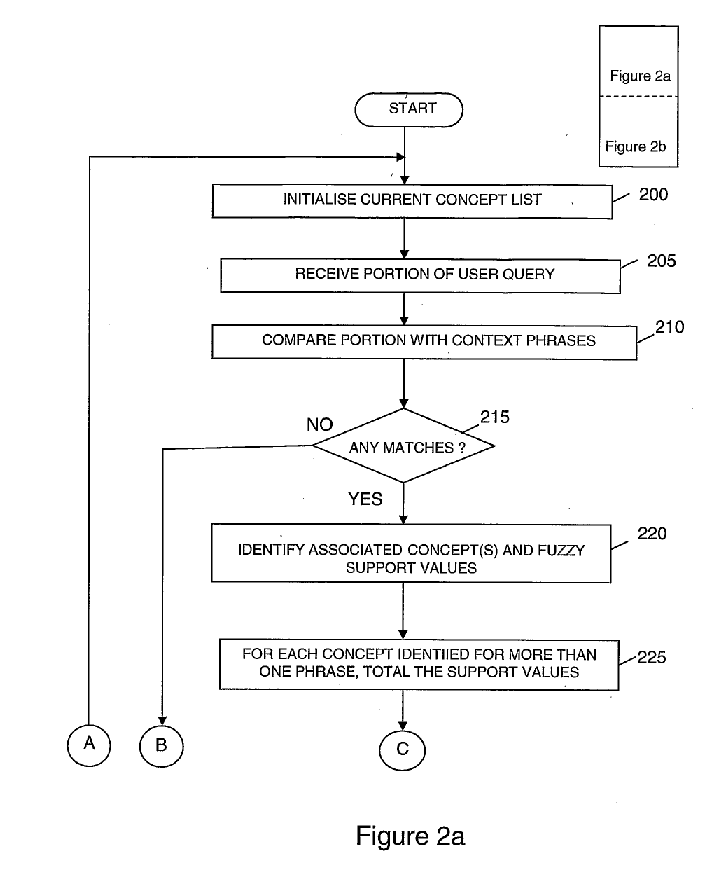

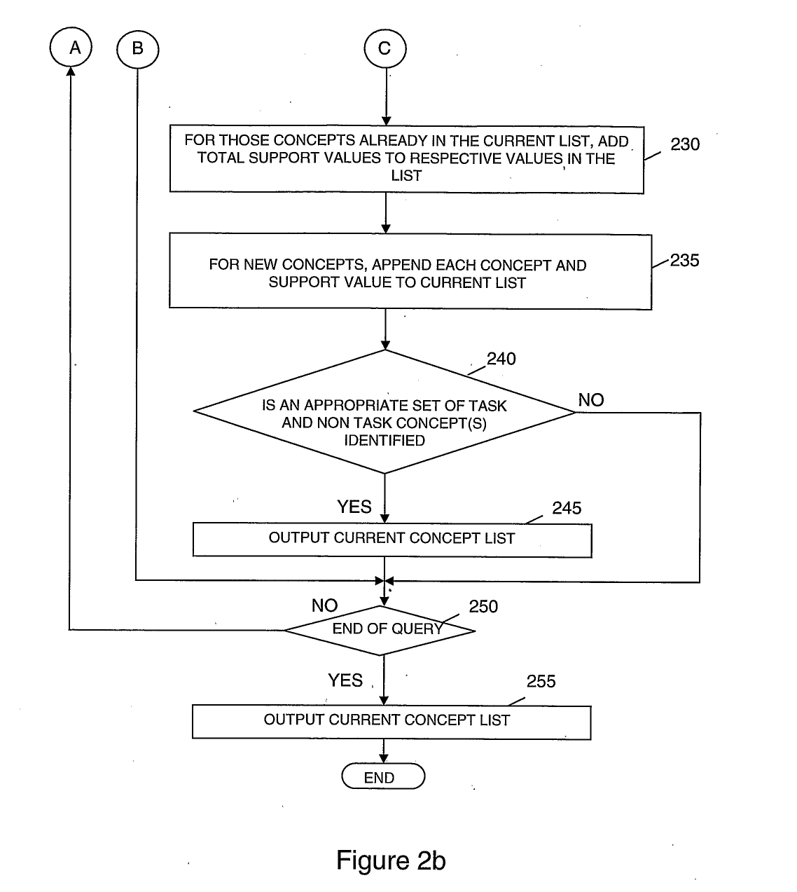

Preferred steps in operation of the fuzzy concept mapper 115 for identifying one or more concepts of relevance to a new user query will now be described with reference to FIG. 2. The process to be described may operate to analyse a user query that has been received complete, e.g. in the form of an e-mail, or to analyse portions of a user query as it is being received, e.g. during an ongoing conversation between a call centre operator and a customer.

Referring to FIG. 2, the preferred process begins at STEP 200 by initialising the current concept list for the user query so that the process begins with an empty list, or a list comprising one or more default concepts with associated fuzzy support values. A portion of the user query is received at STEP 205 from the phrase chunker 110. At STEP 210 the received portion is compared with context phrases stored in the context phrase database 125. If, at STEP 215, no matching context phrases are found, then processing proceeds to STEP 250 to determined whether the end of the user query has been reached and hence whether or not to move on to the next portion or to terminate.

If, at STEP 215, one or more matching context phrases are found, then at STEP 220 any predefined relationships between those matching context phrases and associated concepts stored in the ontology database 120 are used to select the associated concepts and their respective fuzzy support values. The support values indicate the relevance of each selected concept to the respective matching context phrase and hence to the received portion of the user query. Where a particular concept is selected in respect of more than one matching context phrase then at STEP 225 the respective fuzzy support values are summed to give a total fuzzy support value for the concept in respect of the received portion. Having selected one or more concepts of potential relevance to the user query, each with a fuzzy support value, the next stage in the process is to update the current concept list for the user query. This is achieved in two stages: firstly, at STEP 230, for each selected concept already recorded in the current concept list, by adding the respective fuzzy support value to that recorded in the list to update the list; and secondly, at STEP 235, for each selected concept not already recorded in the list, appending the selected concept and its fuzzy support value to the list.

Having updated the current concept list with the results from analysing that portion of the user query received at STEP 205, then at STEP 240 a test is performed to determine whether an appropriate combination of a task concept and one or more associated non-task concepts, according to the arity value defined for the task concept in the ontology (120), has been identified for the user query. If so, then at STEP 245 the current concept list is output to the action selector 130 and at STEP 250 the test is performed to determine whether any more of the user query remains to be analysed. If, at STEP 240, an appropriate combination of concepts has not yet been identified, then the current concept list is not output at this stage and processing proceeds to STEP 250 to check for the end of the user query.

If, at STEP 250, the end of the user query has been reached, then at STEP 255 the current concept list is output to the action selector 130 whether or not an appropriate combination of task and non-task concepts has been identified. Otherwise, if not the end of the user query, processing returns to STEP 205 to receive a next portion of the user query to analyse.

It is particularly advantageous, where a user query is being processed while it is being received at the query input 105, for example when the output from voice recognition means are being processed in real time, that the current concept list is output to the action selector as soon as an appropriate combination of task and non-task concepts has been identified. In this way the latest current concept list is made available to the action selector 130 with potentially useful task and non-task information, even though the end of the user query has not yet been reached.

According to a preferred embodiment of the present invention, the fuzzy concept mapper 115 may be arranged to operate according to a known fuzzy comparison algorithm to enable a fuzzy comparison to be made between portions of a user query received from the phrase chunker 110 and context phrases stored in the context phrase database 125. In particular, operating a fuzzy comparison algorithm enables the fuzzy concept mapper 115 to identify matching context phrases even though the user query contains typing or spelling errors.

The action selector 130 receives the current concept list from the fuzzy concept mapper 115. The action selector 135 attempts to select and to effect one or more actions specified in the action database 135 of relevance to the concepts in the current concept list. The action database 135 contains information defining predetermined actions that should be performed when a given set of one or more current concepts has been identified (by the fuzzy concept mapper 115) in respect of a received user query. For example, if the current concepts are “freestyle_6010” and “pricing”, then the action database 135 may contain the address for a specific web-page where information on the pricing of products including the freestyle_6010 is available. If the concepts are “PSTN_line” and “fault”, then the action database 135 may specify a link to the user interface of a PSTN fault reporting process.

The action selector 130 looks for concepts of two types: task and non-task. Tasks are general concepts corresponding, for example, to typical call centre activities, e.g. “give_price” and “sell”. If the current concept list includes more than one identified task concept, then the “current task” concept is considered by the action selector 130 to be that task concept with the highest fuzzy support value in the list. Each task concept has an arity value n associated with it in the ontology (120). The arity n of a task specifies how many and what other concepts are needed to complete the task. If an appropriate combination of concepts has been identified by the fuzzy concept mapper 115 then there will be at least n other concepts present in the current concept list for the current task. If there are more than n other concepts in the list, the action selector 130 selects those n other concepts from the list having the greatest fuzzy support values. The action selector 130 takes this combination of the current task and n other tasks and compares it with sets of concepts defined in the action database 135 in order to find a relevant action.

In the case where a task concept could not be identified by the fuzzy concept mapper 115, then a default task of show general_information of arity 1 is assumed by the action selector 130. In this case, it may be necessary to trigger the concept resolution dialogue module 150 to ask the user to be more specific as to which of the other concepts identified in the current concept list are most appropriate to the user's query or to prompt the user to select a task more appropriate to the user's query than show_general_information. For example, if the user decides in response to a dialogue with the concept resolution dialogue module 150 that they would like to purchase an internet_access product, then whereas it would be appropriate (from the ontology) to apply the show_general_information task to the internet_access product, it would not be appropriate to apply the task sell because the user must first choose between dial_up, mid-band and broadband variations of the internet_access product if the product is to be purchased. In this latter case the concept resolution dialogue module 150 presents the user with a list of possible child nodes to the internet_access concept, read from the ontology (120), from which the user can then select. This dialogue may be repeated until an appropriate node is found—typically this will be a leaf-node of the ontology (120). All leaf nodes are considered appropriate; whereas other nodes of the ontology are considered appropriate only if the task and non-task concepts appear in a set of concepts defined in the action database 135 in respect of a particular action.

As mentioned above, an action may comprise, for example, a link to a web page or to a user interface for a fault reporting system or product ordering/information system, or to a credit card payment system. To effect actions such as these, the action selector 130 may either invoke another software application program referenced in the action database 135 to execute a required interface, or it may generate a standard request message for sending to a network address defined in the action database 135 and to output the response (140). Preferably, the action selector 130 does not necessarily start processes to effect actions; rather it takes users to those parts of a system where they can do this for themselves. Typically, this will involve sending an HTTP request message to the URL of a web-based application program and displaying the resultant web page to the user. An action may be highly structured and represent a semantically correct reformulation of an originally received input query. Hence, high quality results may be achieved in response.

As mentioned above, the apparatus 100 is provided with a concept resolution dialogue module 150 to assist a user in finding an appropriate concept where either no relevant task concept has been found by the apparatus 100 for a given user query or a concept that has been identified is “inappropriate” in that there is no corresponding action defined in the action database 135. This situation may arise for example where a user has employed a particularly broad term in a query and the apparatus 100 requires the user to be more specific in order for an appropriate actionable concept to be identified. For example, if a user entered a query “What is the cost of Broadband?”, then the fuzzy concept mapper 115 may select the concepts “dial-up”, “mid-band” and “adsl” from the ontology (120) in respect of the term “broadband” because “broadband” refers to a group of products. However, whereas these concepts each have links to specific actions in the action database 135, the term “broadband” itself does not. Therefore the concept resolution dialogue module 150 may be triggered to prompt the user to select one of the concepts “dial-up”, “mid-band” or “adsl” in place of the term “broadband” in order to progress the query.

To give another example, if a user referred in a query to a fault with a “friends_and_family” product, it would be apparent from the ontology (120) that “friends_and_family” is not associated with the task concept “Fault”; the product is not “repairable” as such (it is user-defined). In this case the concept resolution dialogue module 150 would be required to help the user to identify the appropriate task concept to associate with the “friends_and_family” product in order to progress the user query. The user would be prompted to select from one or more alternative task concepts that are relevant to the “friends_and_family” product as defined in the ontology (120). In this respect, through knowing and refining a user query in terms of a concept and corresponding task, preferred embodiments of the present invention are particularly effective in selecting appropriate actions in respect of user queries.

For example, for the user query “my internet is not working”, the fuzzy concept mapper 115 may identify the following list of current concepts: broadband, mid-band and fault (with corresponding fuzzy support values), and outputs this current concept list to the action selector 130. Given the concepts broadband, mid-band and fault, the action selector 130 treats fault as the current task. However, the fault task has an arity value of 1 defined in the ontology so the action selector 130 may determine that a choice must be made between broadband and mid-band in order to define what is meant by “internet” in the user query in the context of the fault task. This choice may be made by triggering the concept resolution dialogue module 150 to query the user:

“Select which product you mean:
Broadband
Mid-band”

Once an appropriate selection has been made by the user, a query can be formulated by the action selector 130, based upon the original user query, that is structured and efficient having converted an ambiguous natural language text into precise concepts defined in the ontology (120) and which are also understandable by the user.

Overview of Concept Editor

The concept editor 145 of the present embodiment is now described in overview with reference to FIG. 3.

As shown in FIG. 3, the concept editor 145 includes a Graphical User Interface (GUI) 300, a document input module 310, a key-phrase extractor module 320 and a parent node classifier module 330. In the present embodiment, an initial process is undertaken by a system developer to create an initial ontology and to train the classifiers used in the parent node classifier module 330. However, a system administrator is able to use the concept editor 145 in order to add new concepts to the ontology (stored in the ontology database 120) and to add new key phrases to the context phrase database 125 in a semi-automated fashion.

In order for a system administrator to add a new concept for which some associated documents are available in electronic format, the administrator, via the GUI 300, advises the concept editor 145 that a new concept is to be added and he informs the document input module 310 of the location of the relevant documents. The document input module 310 gets the documents and processes them to obtain a simple text file containing the text content of the documents. Note that in the present embodiment each document is processed individually, however in alternative embodiments the administrator could be invited to group two or more documents together, to thereafter be processed as a single document.

Each resulting text file is then simultaneously output from the document input module to both the key-phrase extractor 320 and the parent node classifier 330. The key-phrase extractor module 320 extracts phrases from each input text file which, based upon a statistical analysis of the input text file with reference to a “corpus of documents” (discussed below), it considers are most characteristic of the input text file. The parent node classifier module 330 selects, based upon a similar statistical analysis of each input text file, one or more possible prospective parent nodes within the ontology stored on the ontology database 120 underneath which the new concept may be added.

Via the GUI 300, the administrator is provided with a number of options which he then may choose between (or if he feels that none of the presented options are appropriate he may still enter his own selections), and these selected options are then used to update the context phrase database 125 and the ontology database respectively. Additionally at this point, the user is presented with the option to specify one or more actions to store in the action database 135 to be associated with various combinations of the new concept and task concepts.

Reference is made above to a “corpus of documents”. The corpus of documents is the sum total of documents which is associated with concepts within the ontology stored in the ontology database 125. In the present embodiment, this includes the documents originally used by the system developer who created the initial system as well as any further documents added to the corpus later by the system administrator (as part of adding new concepts). The documents themselves are stored (in the present embodiment simply in the form of simple text files) in a separate database (not shown) to that storing the ontology per se, but each concept in the ontology which has one or more documents associated with it may include a reference to each such associated document by way of an attribute; additionally, or alternatively, each document in the document database may include, or may be stored in association with, a reference to its associated concept (or concepts where one document refers to more than one concept). The classification performed by the parent node classifier module 330 actually looks for the closest document(s) in respect of each input text, but the corresponding concept(s) is identified from this and thus the proposed candidate parent node.

Key-Phrase Extraction

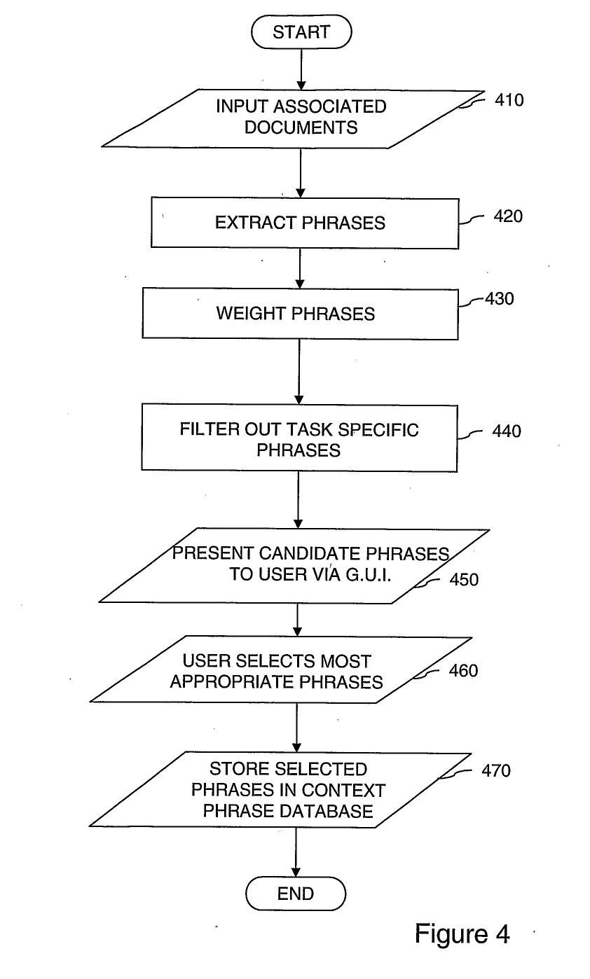

Referring now to FIG. 4, the steps performed by the concept editor 145 in order to present candidate key-phrases to the system administrator/user are described below.

At step 410 the documents associated with the new concept to be added are identified to the document input module 310 which obtains a copy of each document and pre-processes it to extract any text contained therein (i.e. it strips out any pictures or other non-textual matter and resaves the resulting text as a simple text file instead of a word-processing or electronic document format such as a .doc or a .pdf type file). Furthermore, in the present embodiment, term stemming is carried out at this stage. As is well-known in the art, term stemming involves removing the endings from words which may change in dependence upon the grammatical role played by the word, with the aim of leaving an invariant word root or stem (eg “bridge”, “bridging”, “bridges”, “bridged” would all be stemmed to “bridg”).

Upon completion of step 410 each stemmed text file is passed to the key-phrase extractor module 320 and then, at step 420, phrases are extracted from the resulting text file. The method employed in the present embodiment for extracting phrases is to select all phrases of up to five words in length which do not cross punctuation marks, and then to filter out any phrases which end in a word contained in a stop word list (which is provided initially by the system developer, but which may be further amended by a system administrator—the stop word list ideally contains words which are not useful in distinguishing one topic from another such as “and”, “but”, “as”, etc.).

For example, the phrases retrieved in the sentence “This is a short example, but easy to understand.” are:

{short, example, easy, understand}

{a short, short example, but easy, to understand}

{is a short, a short example, easy to understand}

{this is a short, is a short example, but easy to understand}

{this is a short example}

The phrases in this example are not stemmed. In the program the representation for the last phrase would actually be:

{thi i a short exampl}

After retrieving the phrases in step 420, the method proceeds to step 430 in which the extracted phrases are weighted. In the present embodiment, this is done by, for each term in the document calculating a weight according to the following formula:
wᵢⱼ=(tfᵢⱼ/(tfᵢ/nᵢ))*ridfᵢ
where

wᵢⱼ is the weight of the iₜₕ term in the jₜₕ document.

tfᵢⱼ is the term frequency of the i^{th} term in the jₜₕ document.

tfᵢ is the term frequency of the i^{th} term in the corpus.

nᵢ is the number of documents term i occurs in, in the corpus.

ridfᵢ is the residual inverse document frequency which is calculated according to the formula below.
ridfᵢ=log₂N/nᵢ−log₂(1−e^{-tf/N})
where ridfᵢ is the residual inverse document frequency of the i^{th} term;

N is the total number of documents in the corpus;

nᵢ is the number of documents term i occurs in within the corpus; and

tf is the frequency of term i in the corpus.

Using these formulae the system generates a weight for each phrase in each document. The weight gives an indication of how useful it is as a characterising phrase for the respective document. Those phrases with the highest weights (and which are not filtered out in step 440) ultimately are presented to the administrator as candidate concept relevant phrases.

Upon completion of step 430 the method proceeds to step 440 in which the phrases extracted and weighted in the preceding steps are examined to see if any of them already appear in the context-phrase database 125 as being relevant to task concepts. For example, phrases such as “debit card” and “monthly payment” might score quite highly (i.e. be given a high weighting) in a document about the pricing of a new product, but they are also likely to appear as key-phrases in respect of the pricing task in which case they are filtered out (which is sensible because they are likely to be bad at distinguishing one product from another).

Upon completion of step 440 the method proceeds to step 450 in which the highest weighted phrases are presented to the user via the GUI 300 for selection by the user. The exact choice of which phrases to present to the user can be varied according to circumstances or user preferences. For example, the top x phrases could be presented where x is some user settable number with a default value such as 10. Alternatively, all phrases with a weighting over some user definable threshold could be presented to the user, or a combination of these strategies could be used, for example all phrases with a weighting over the threshold provided there are at least x, but otherwise the top x regardless of whether they all have a weighting over the threshold, etc. The GUI 300 also provides the user with an opportunity to enter his own key phrase(s) in the event that he feels that this is necessary.

In the following step, step 460, the user selects key phrases for associating with the new concept (and/or may enter his own key phrases). It is preferable if the number of key phrases chosen is not too large and so an upper limit of at most say 20-phrases may be set by the user, or by the system developer, etc.

Finally, in step 470, the phrases selected (and/or entered) in step 460 are stored in the context phrase database 125 in association with the new concept.

Parent Node Classification

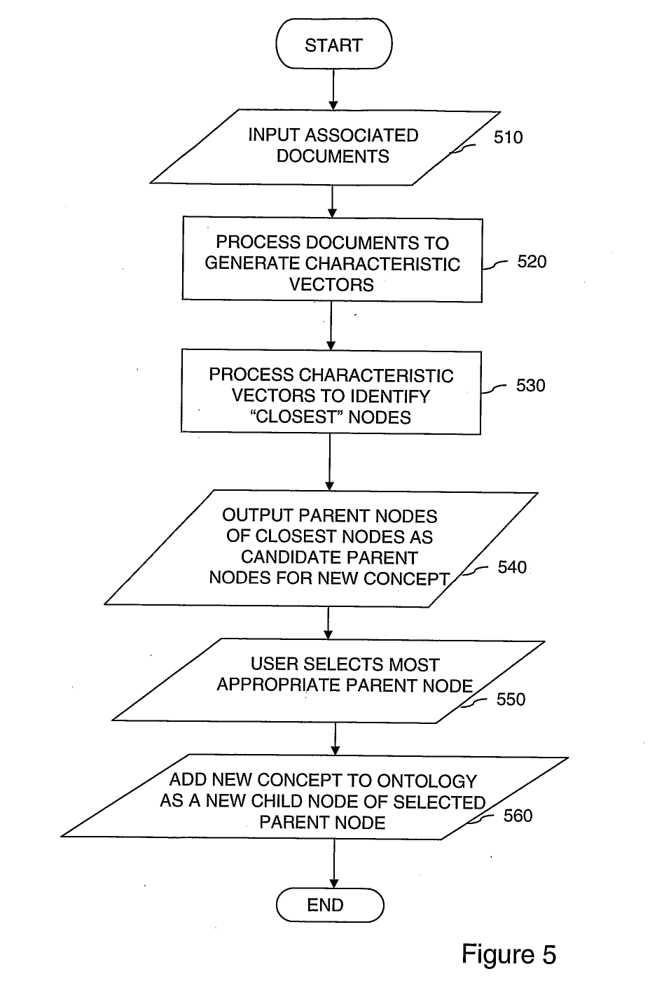

Referring now to FIG. 5, the steps performed by the concept editor 145 in order to present candidate parent nodes to the system administrator/user are described below.

At step 510 the documents associated with the new concept to be added are identified to the document input module 310 which obtains a copy of each document and pre-processes it to extract any text contained therein (i.e. it strips out any pictures or other non-textual matter and resaves the resulting text as a simple text file instead of a word-processing or electronic document format such as a .doc or a .pdf type file). Furthermore, in the present embodiment, term stemming is carried out at this stage. (It will be apparent to the reader that step 510 is identical to step 410 and in fact in the present embodiment the process is only carried out once by the document input module 310 which outputs the same data to either the key-phrase extractor 320—for carrying out steps 420 to 440—or to the parent node classifier 330—for carrying out steps 520 and 530—respectively.)

Upon completion of step 510 each stemmed text file is passed to the parent node classifier module 330 for carrying out step 520 in which the stemmed text document is processed to generate characteristic vectors. In order to do this, in the present embodiment, an initial corpus of documents is initially pre-processed using Latent Semantic Indexing (LSI) to generate a set of 3 matrices which characterise the corpus of documents. The matrices resulting from the LSI are then used together with a term-frequency matrix generated for each new document to generate the characteristic vectors. The details of the procedure are outlined below but for further details, the reader is referred to the references given at the end of this description.

Upon completion of step 520, the resulting characteristic vector for each new document is input to a Support Vector Machine (SVM) which has been previously trained on the “initial” corpus of documents and which therefore outputs the documents which it feels are most closely related to the input document. From these documents, the nodes to which these documents correspond are determined and then the parent nodes of these nodes are identified and form the final output of step 530. Again the details of the procedure for training and employing the SVM are outlined below but for more details the reader is again referred to the references given at the end of this description.

Upon completion of step 530 the method proceeds to step 540 in which the identified parent nodes are presented to the user via the GUI 300 as candidate parent nodes for selection of the most appropriate one by the user. The exact choice of which candidate parent nodes to present to the user can be varied according to circumstances or user preferences. For example, the top x candidate nodes could be presented where x is some user settable number with a default value such as 5 per document. Alternatively, all candidate nodes whose corresponding document was given a “closeness” value by the SVM of below some user definable threshold could be presented to the user, or a combination of these strategies could be used. The GUI 300 also provides the user with an opportunity to enter his own parent node in the event that he feels that this is necessary.

In the following step, step 550, the user selects an actual parent node for the new concept from amongst the presented candidate parent nodes (or he may enter another node as the parent node if he rejects all of the presented nodes as inappropriate).

Finally, in step 560, the new concept is added to the ontology stored in the ontology database 120 underneath the parent node actually selected in step 550. At this point, the user may be given the opportunity to add or amend any of the concept's attributes, sub-nodes, relationships, etc.

Outline of Mathematical Details Concerning LSI and SVM Training and Use

From the documents contained in the “initial” corpus the system generates a term-frequency matrix using tfidf.

aardvark apple . . . zebra

| | | | |
|---|---|---|---|
| Document 1 | 0 | 0.8 | 0 |
| Document 2 | 0.75 | 0 | 0 |
| . . . | | | |
| Document n | 0.3 | 0 | 0.6 |

The system then reduces the dimensionality of this matrix using the known Latent Semantic Indexing (LSI) method. After singular value decomposition has been applied to the matrix, three matrices D (the document matrix) S (the dimensionality matrix) and T (the term matrix) are created, which return the original matrix when multiplied by each other. The original dimensionality matrix can be large, but if the least important dimensions are removed, D*S*T approaches the original matrix as close as possible given the number of dimensions. The original matrix can be reduced to a dimensionality of between 100 and 300 columns without too much loss of information.

These matrices are then used as input data to a classifier. A radial-based Support Vector Machine is used as the classifier. Each row of D is matrix multiplied with S to give one training vector for the SVM. The SVM is trained in the known manner.

Once a classifier has been trained, new concepts can be placed at the correct position in the ontology by using the classifier. Given a new concept with i sample documents the documents are appended into a single document which is stemmed and the weightings for each term are found. This input vector is matrix multiplied by T*S⁻¹ which is then passed as the input to the SVM. This gives classification rates for all parents in the ontology for the document, from which the system, in the present embodiment, selects the 5 best results for suggestions for the correct place of this concept in the ontology. (Note that, as an alternative, this process could be performed in respect of each document. Thus for i documents there would be a maximum of 51 suggestions for the position in the ontology.)

Note that the SVM's may be automatically retrained periodically to reflect newly added concepts as the system as a whole grows. This may be done largely automatically since at each stage a user has confirmed that each new concept has been added to an appropriate place in the ontology.

### EXAMPLE

A highly simplified example of parent node classification and key phrase extraction is set out below for illustrative purposes.
Ontology: 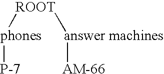
Document 1: P-7 has a 27 number memory
Document 2: P-7 is a new phone from BT.
Document 3: AM-66 can save up to 30 messages. Messages can be remotely retrieved from the memory.

Document Database:

| Product Concept | Documents |
|---|---|
| P-7 | Document 1, Document 2 |
| AM-66 | Document 3 |

New Concept P-10
New Document: “P-10 is a cordless phone. It has a 40 number memory.”
Problems:

1) where to place P-10 in, the ontology

2) What phrases are relevant for describing P-10

1) Where to Place P-10 in the Ontology

Remove stop-words and stem.
Generate TF matrix. (TFICF is like TFIDF but all the documents attached to one concept are treated as a single document) for Documents 1-3.

From the texts, for each term find the overall concept frequency (the number of concepts each term is in) and the term frequency (the total number of times each term occurs in the corpus of all the documents associated with the ontology.) We then calculate associated statistics tf/N (term frequency/total number of concepts N=2),exp(tf/N), log2(N/ni) where N is the total number of concepts, ni is the number of documents containing the i^{th} term, and ridf (residual inverse document frequency) which is our new measure for finding the likely content words. Ridf is calculated using the following formula.

ridf = log₂N/nᵢ − log₂(1 − e^{-tf/N})

| | Concept | Term | | exp | log2 | | |
|---|---|---|---|---|---|---|---|
| Term | frequency | Freq | tf/N | (tf/N) | N/ni | Ridf | tf1/ni |
| AM-66 | 1 | 1 | 0.08333 | 0.9200 | 1 | 0.92004 | 1 |
| BT | 1 | 1 | 0.08333 | 0.9200 | 1 | 0.920044 | 1 |
| message | 1 | 2 | 0.16666 | 0.8464 | 1 | 0.84648 | 2 |
| memory | 2 | 2 | 0.16666 | 0.8464 | 0 | −0.15352 | 1 |
| new | 1 | 1 | 0.08333 | 0.9200 | 1 | 0.92004 | 1 |
| number | 1 | 1 | 0.08333 | 0.9200 | 1 | 0.92004 | 1 |
| P-7 | 1 | 2 | 0.16666 | 0.8464 | 1 | 0.84648 | 2 |
| phon | 1 | 1 | 0.08333 | 0.9200 | 1 | 0.92004 | 1 |
| remot | 1 | 1 | 0.08333 | 0.9200 | 1 | 0.92004 | 1 |
| retriev | 1 | 1 | 0.08333 | 0.9200 | 1 | 0.92004 | 1 |
| say | 1 | 1 | 0.08333 | 0.9200 | 1 | 0.92004 | 1 |

Next term frequency statistics are found for individual concepts. As shown below. From the above corpus statistics and the concept statistics shown below we calculate the tfridf measure according to the following formula:
   tfridf=tfᵢⱼ*(log₂ N/nᵢ−log₂(1−e^{-tf/N}))
Thus each term has a weight associated with it for each concept. An alternative weight is given in the table wij and is calculated by:
   wᵢⱼ=(tfᵢⱼ/(tfᵢ/nᵢ))*ridf

Term Frequency

| | AM- | | | | | | | | | | |
|---|---|---|---|---|---|---|---|---|---|---|---|
| | 66 | BT | memory | message | new | number | P-7 | phon | remot | retriev | sav |
| P-7 | 0 | 1 | 1 | 0 | 1 | 1 | 2 | 1 | 0 | 0 | 0 |
| AM-66 | 1 | 0 | 1 | 2 | 0 | 0 | 0 | 0 | 1 | 1 | 1 |

tfridf

| | AM- | | | | | | | | | | |
|---|---|---|---|---|---|---|---|---|---|---|---|
| | 66 | BT | memory | message | new | number | P-7 | phon | remot | retriev | sav |
| P-7 | 0 | 0.92 | −0.153 | 0 | 0.92 | 0.92 | 1.69 | 0.92 | 0 | 0 | 0 |
| AM-66 | 0.92 | 0 | −0.153 | 1.69296 | 0 | 0 | 0 | 0 | 0.92 | 0.92 | 0.92 |

wij

| | AM- | | | | | | | | | | |
|---|---|---|---|---|---|---|---|---|---|---|---|
| | 66 | BT | memory | message | new | number | P-7 | phon | remot | retriev | sav |
| P-7 | 0 | 0.92 | −0.153 | 0 | 0.92 | 0.92 | 0.84 | 0.92 | 0 | 0 | 0 |
| AM-66 | 0.92 | 0 | −0.153 | 0.84648 | 0 | 0 | 0 | 0 | 0.92 | 0.92 | 0.92 |

Because these matrices are very large for document statistics we need to reduce the dimensionality of the matrix before classifying. Thus, once we have the weightings we apply a singular value decomposition to the weighting matrix M. M=T*S*D^{T}

$$terms {{x}_{t \times d}}^{documents} = {{T}_{0}}_{t \times m} \begin{matrix}* & & & & & & \\ & * & & & & & \\ & & * & & & & \\ & & & & * & & \\ & & & {S}_{0} & & * & \\ & & & & & & * \\ & & & & m \times m & & \end{matrix} {{D}_{0}^{′}}_{m \times d}$$

$$x = {T}_{0} {S}_{0} {D}_{0}^{′}$$

Matrix X

| | P-7 | M-66 |
|---|---|---|
| AM-66 | 0 | 0.92 |
| BT | 0.92 | 0 |
| memory | −0.153 | −0.153 |
| message | 0 | 0.846 |
| new | 0.92 | 0 |
| number | 0.92 | 0 |
| P-7 | 0.84 | 0 |
| phon | 0.92 | 0 |
| remot | 0 | 0.92 |
| retriev | 0 | 0.92 |
| sav | 0 | 0.92 |

Applying Singular Value Decomposition Gives:

| T | |
|---|---|
| 0.28513 | −0.23148 |
| 0.2306 | 0.28622 |
| −0.0858 | −0.0091 |
| 0.5247 | −0.42596 |
| 0.2306 | 0.28622 |
| 0.2306 | 0.28622 |
| 0.4236 | 0.52578 |
| 0.2306 | 0.28622 |
| 0.28513 | −0.23148 |
| 0.28513 | −0.23148 |
| 0.28513 | −0.23148 |
| S | |
| 2.509 | 0 |
| 0 | 2.4992 |
| D | |
| 0.6288 | 0.7775 |
| 0.7775 | −0.629 |

Each concept input vector is ready to be used as an input vector to train a support vector machine.
It can be seen that for n concepts there will be n input vectors to the SVM. If necessary the dimensionality of the input vectors can be further reduced by using t′ as the first k columns of t, s′ as the top kth rows and columns of s, and d′ as the first kth rows of d.
e.g. In this example

$$\begin{matrix}{t}^{′} = 0.28513 \\ 0.2306 \\ - 0.08577 \\ 0.5247 \\ 0.2306 \\ 0.2306 \\ 0.4236 \\ 0.2306 \\ 0.28513 \\ 0.28513 \\ 0.28513 \\ {s}^{′} = 2.5088\end{matrix}$$

New input vectors are

| P-7 | AM-66 |
|---|---|
| 0.6288 | 0.7775 |

With the dimensionality reduced from 2 to 1.

The statistics for the documents corresponding to the new concept (P-10) are found by calculating the tfridf measure.

| | Term frequencies: | | |
|---|---|---|---|
| | tf | ridf | tdridf |
| Cordless | 1 | 0 | 0 |
| Phon | 1 | 2.34568 | 2.345 |
| Number | 1 | 2.345677 | 2.345 |
| Memory | 1 | 0.661728 | 0.66173 |

To make an input vector:

| | P-10 |
|---|---|
| AM-66 | 0 |
| BT | 0 |
| memory | −0.15 |
| message | 0 |
| new | 0 |
| number | 0.92 |
| P-7 | 0 |
| phon | 0.92 |
| remot | 0 |
| retriev | 0 |
| sav | 0 |

If the dimensionality stays 2, the input vector is multiplied by t*s⁻¹ to create a new concept vector:

1.097
1.32
   If dimensionality is reduced (to 1) the input vector is multiplied by t′*s′⁻¹. Because the number of columns of s′ is reduced to 1, the outcome will only be the first row of the input vector above:

1.097

This vector will be presented to the SVM classifier. The classifier finds P-7 as the nearest concept and the parent node of P-7 (phones) is presented to the user as the most likely parent of P-10.

2) What Phrases are Relevant for Describing P-10

For each document in the corpus the text is made into phrases of up to 5 terms

For example, the text of the associated document “P-10 is a cordless phone. It has a 40 number memory” is made into phrases:

{P-10,is,a,cordless,phone,it,has,a,40,number,memory}

{P-10 is, is a, a cordless, cordless phone, it has, has a,a 40, 40 number, number memory}

etc.

Phrases which end in a stop word are removed.

{P-10,cordless,phone,number,40,memory}

{cordless phone,number memory}

etc.

The rfidf (see above) is calculated for all the phrases in the corpus. (calculation is not shown here, but is the same as above but using phrases in addition to single terms) and for the new text. Each phrase in the new text will then have an associated weight. Those phrases with the highest weight in the new document will be presented to the user as potential concept relevant phrases.

General Points

The apparatus 100 may be implemented according to an industrial standard J2EE as a server and client model. All the software may be written using Java: Java Beans, Java Servlets and JSPs. The apparatus 100 has been deployed on a J2EE platform from the BEA system. The databases 120, 125 and 135 are implemented as SQL server and Oracle databases. The server side includes the action selector 130, ontology database 120, fuzzy concept mapper 115 and phrase chunker 110. The client side includes JSP web pages and dialogue manager.

### REFERENCES

For a more detailed explanation of State Vector Machines and the mechanics of performing Singular Value Decomposition and Latent Semantic Indexing, the reader is referred to the following references:

SVMs:

“Learning with kernels” Bernhard Scholkopf and Alexander J. Smola MIT Press 2002 ISBN 0-262-194575-9
   Singular Value Decomposition:
Gentle, J. E. “Singular Value Factorization.” §3.2.7 in Numerical Linear Algebra for Applications in Statistics. Berlin: Springer-Verlag, pp. 102-103, 1998.
Golub, G. H. and Van Loan, C. F. “The Singular Value Decomposition” and “Unitary Matrixes.” §2.5.3 and 2.5.6 in Matrix Computations, 3rd ed. Baltimore, Md.: Johns Hopkins University Press, pp. 70-71 and 73, 1996.
Nash, J. C. “The Singular-Value Decomposition and Its Use to Solve Least-Squares Problems.” Ch. 3 in Compact Numerical Methods for Computers:
Linear Algebra and Function Minimisation, 2nd ed. Bristol, England: Adam Hilger, pp. 30-48, 1990.
Press, W. H.; Flannery, B. P.; Teukolsky, S. A.; and Vetterling, W. T.

“Singular Value Decomposition.” §2.6 in Numerical Recipes in FORTRAN: The Art of Scientific Computing, 2nd ed. Cambridge, England: Cambridge University Press, pp. 51-63, 1992.

Latent Semantic Indexing

http://javelina.cet.middlebury.edu/lsa/out/cover_page.htm

1. A method of assisting a user to add a new node to an ontology stored in an ontological database, the method comprising:
analysing one or more documents and/or groups of documents associated, by the user, with the new node to be added to the ontology, to generate a characteristic vector for the or each associated document or group of documents,
performing a classification step using the or each characteristic vector to obtain one or more indications of possibly closely related nodes, identifying the parent node or nodes of at least one or more of the possibly closely related nodes, and
presenting the identified parent node or at least one of the identified parent nodes where more than one is identified, for possible selection by the user.

2. A method according to claim 1 wherein the characteristic vector is generated by performing latent semantic indexing upon the one or more documents and/or groups of documents.

3. A method according to claim 1, wherein the classification step uses a support vector machine trained on a corpus of documents pre-assigned to an original set of nodes forming the ontology as part of the initial setting up of the ontology.

4. A method according to claim 1 further including analysing the or each document to identify possibly characteristic phrases from the documents which might be good indicators of a reference to the concept associated with the new node, and presenting these as candidate phrases to the user to assist a user in identifying key phrases for associating with the new node.

5. A method according to claim 4 wherein the characteristic phrase analysis involves performing a residual inverse document frequency type analysis on phrases extracted from the or each document.

6. A method according to any preceding claim claim 1, wherein said concepts include task concepts and non-task concepts, and wherein the ontology defines, for each task concept, an indication of the number of non-task concepts required to implement a corresponding task.

7. A method according to any preceding claim claim 1, wherein the ontology stores relationships between predefined phrases and said concepts in the ontology as fuzzy relationships each represented by a respective fuzzy support value.

8. Apparatus for assisting a user to add a new node to an ontology stored in an ontological database, the apparatus comprising:
analysing means for analysing one or more documents and/or groups of documents associated, by the user, with the new node to be added to the ontology, to generate a characteristic vector for the or each associated document or group of documents,
a classifier for performing a classification step using the or each characteristic vector to obtain one or more indications of possibly closely related nodes and thereby identifying the parent node or nodes of at least one or more of the possibly closely related nodes, and
display control means for controlling a display to present the identified parent node or at least one of the identified parent nodes where more than one is identified, for possible selection by the user.

9. A computer program or programs for carrying out the method of claim 1 during execution.

10. A carrier medium carrying the program or programs of claim 9.
